(19) United States
(12) Patent Application Publication
(10) Pub. No.: US 2018/0293367 A1
(43) Pub. Date: Oct. 11, 2018

(54) Multi-Factor Authentication via Network-Connected Devices

(71) Applicant: Google LLC, Mountain View, CA (US)

(72) Inventor: Andrew J. Urman, Mountain View, CA (US)

(73) Assignee: Google LLC, Mountain View, CA (US)

(21) Appl. No.: 15/909,500

(22) Filed: Mar. 1, 2018

Related U.S. Application Data
(60) Provisional application No. 62/481,977, filed on Apr. 5, 2017.

(51) Int. Cl. G06F 21/31; G06F 21/32; H04L 29/06; G06N 99/00; G10L 17/22; G10L 17/00; G06K 9/00

(52) U.S. Cl. CPC G06F 21/316; G06F 21/32; H04L 63/0861; H04L 67/10; G10L 17/22; G10L 17/005; G06K 9/00288; G06N 99/005

(57) ABSTRACT

Multi-factor authentication via network-connected devices is described, and techniques provide for generating and utilizing behavioral authentication factors for multi-factor authentication of user identities. Behavioral authentication factors are learned by training models, using machine learning techniques, from user behaviors sensed by network-connected devices and monitored by a service. A system for multi-factor authentication via network-connected devices receives indications of user activity from network-connected devices and detects a pattern of activity that is compared to the behavioral authentication factor to determine a confidence level that the pattern of activities matches the behavioral authentication factor, and authenticates the user identity if the confidence level exceeds a threshold for authentication of the user identity.

### RELATED APPLICATION

This application claims priority under 35 U.S.C. § 119(e) to U.S. Provisional Patent Application 62/481,977, filed on Apr. 5, 2017, which is incorporated herein by reference in its entirety.

### BACKGROUND

Distributed computing systems, including wireless mesh networks, are used to connect devices to each other, and to cloud-based services. These distributed computing systems are increasingly popular for sensing environmental conditions, controlling equipment, and securely providing information, control, and alerts to users via applications of the network-connected devices that are connected to the cloud-based services. Various approaches are used in these systems to authenticate the identity of users of the network-connected devices and systems, to provide privacy and security for the users and user-related information.

### SUMMARY

This summary is provided to introduce simplified concepts of multi-factor authentication via network-connected devices. The simplified concepts are further described below in the Detailed Description. This summary is not intended to identify essential features of the claimed subject matter, nor is it intended for use in determining the scope of the claimed subject matter.

Multi-factor authentication via network-connected devices is described, as generally related to a system for generating a behavioral authentication factor that is learned from user behaviors, sensed by network-connected devices, and monitored by a service. A model training system receives device monitoring data describing sensor readings, control commands, and/or user interactions from network-connected devices. The model training system composes a training dataset from the received device monitoring data, structure resources, and/or external resources, and trains a model from the training dataset to generate a behavioral authentication factor.

Multi-factor authentication via network-connected devices is further described, as generally related to a method for authenticating a user identity based on a behavioral authentication factor. The method includes receiving indications of user activity from multiple network-connected devices that are monitored at a service and detecting a pattern of activities in the received indications of user activity. The method also includes comparing the pattern of activities to the behavioral authentication factor to determine a confidence level that the pattern of activities matches the behavioral authentication factor, and authenticating the identity of the user if the determined confidence level exceeds a threshold value for authentication of the user identity.

Multi-factor authentication via network-connected devices is further described, as generally related to a system for authenticating a user identity based on user interactions with network-connected devices. The system receives an indication of a user identity and determines a network-connected device, associated with the user identity, for a user interaction. The system provides an indication of the determined user interaction with the network-connected device, monitors the network-connected device to receive an indication of the user interaction with the network-connected device, and authenticates the identity of the user based on the received indication of the user interaction.

### BRIEF DESCRIPTION OF THE DRAWINGS

Implementations of multi-factor authentication via network-connected devices are described with reference to the following drawings. The same numbers are used throughout the drawings to reference like features and components:

FIG. 1 illustrates an example distributed computing system in which various aspects of multi-factor authentication via network-connected devices can be implemented.

FIG. 2 illustrates an example mesh network system in which various aspects of multi-factor authentication via network-connected devices can be implemented.

FIG. 3 illustrates an example environment in which various aspects of multi-factor authentication via network-connected devices can be implemented.

FIG. 4 illustrates an example structure in an environment in which a distributed computing system can be implemented in accordance with the techniques for multi-factor authentication via network-connected devices described herein.

FIG. 5 illustrates an example of a system for user authentication using behavioral authentication factors in a distributed computing system in accordance with aspects of multi-factor authentication via network-connected devices.

FIG. 6 illustrates an example method of multi-factor authentication via network-connected devices as generally related to training a model for a behavioral authentication factor in the distributed computing system in accordance with the techniques described herein.

FIG. 7 illustrates another example method of multi-factor authentication via network-connected devices as generally related to using a behavioral authentication factor to authenticate a user identity based on user activities in accordance with the techniques described herein.

FIG. 8 illustrates another example method of multi-factor authentication via network-connected devices as generally related to using a user interaction with a network-connected device to authenticate a user identity in accordance with the techniques described herein.

FIG. 9 illustrates an example environment in which a distributed computing system can be implemented in accordance with the techniques for multi-factor authentication via network-connected devices described herein.

FIG. 10 illustrates an example mesh network device that can be implemented in a distributed computing environment in accordance with one or more the techniques described herein.

FIG. 11 illustrates an example system with an example device that can implement aspects of multi-factor authentication via network-connected devices.

### DETAILED DESCRIPTION

Distributed computing systems provide home automation with low-power devices and wireless networks connected to cloud-based services and web-connected user applications. Devices in the distributed computing system are heterogeneous and built with varying capabilities. The hosts or devices included in the distributed computing system range from battery-powered, microcontroller-based devices, which sleep periodically to conserve battery power, to line-powered devices with always-on connectivity in the home, to server farms hosting cloud-based services.

Various security techniques, such as authentication and encryption, are employed to protect users and their data in distributed computing systems. One approach to user authentication is multi-factor authentication that employs multiple, different factors to increase confidence in identification of a user. By including user interaction with securely-connected devices in the distributed computing system, services provide fast and simple methods of increasing security and identification confidence.

When logging into a service, the service can prompt a user to interact with a specific device in the distributed computing system or to enter a key value into a network-connected device with a keypad. The service is continuously monitoring devices in the distributed computing system and can determine the specific types of devices available to perform authentication. The service can dynamically select a device for user authentication or request that a user interact with a predetermined device known to the user and the service.

Many devices in the distributed computing system support relatively simple operations, such as switching a light on or off, sending a contact closure notice or alert when a door opens or closes, and so forth. The amount of information that is transferred over a network for these operations is small compared to some authentication techniques, such as sending camera image data, or biometric scan data. Also, by using devices already installed for home automation, no additional devices dedicated to authentication need to be installed in the environment of the user.

As user security and privacy continues to be a concern, the traditional username/password combination for user identification can be supplemented with security questions and answers. However, remembering the security questions and answers for the many services a user employs is increasingly burdensome for the user. Using devices in the distributed computing environment for authentication eases the burden of remembering the answers to multiple security questions. When a service has low confidence in the identification of a user, the service may prompt the user to interact with a predetermined security device known to the user and the service. The service can prompt the user to interact with the predetermined security device by initiating an alert in a user app, sending a text message to the user, and so forth. When the user interacts with the predetermined security device, the service has a higher confidence in the user's identity.

In an aspect of multi-factor authentication via network-connected devices, devices in the user's environment can be used to authenticate the user and verify that the user is in the environment. For example, when a user is accessing customer support for a service, a customer service representative may ask the user to interact with the predetermined device in the environment or to interact with a specific device. The user interaction with the device can be used to verify the identity of the user, as well as the presence of the user in the environment where customer support is required.

In another aspect of multi-factor authentication via network-connected devices, interactions of the user with devices in the user's environment are monitored over time to train a model that describes normal user activities. The service that continuously monitors the devices in the distributed computing system records interactions with the devices along with additional information, such as location information from a user app on a mobile device, calendar information, and so forth to train a model using any known technique, such as machine learning techniques. The confidence levels in the model become higher over time as more interactions are used to train the model. Once the model is trained, the model can be used by the service to evaluate inputs from the monitoring of devices to determine if a series of interactions matches a particular user identity or to determine if the interactions are indicative of an anomalous situation.

While features and concepts of the described systems and methods for multi-factor authentication via network-connected devices can be implemented in any number of different environments, systems, devices, and/or various configurations, implementations of multi-factor authentication via network-connected devices are described in the context of the following example devices, systems, and configurations.

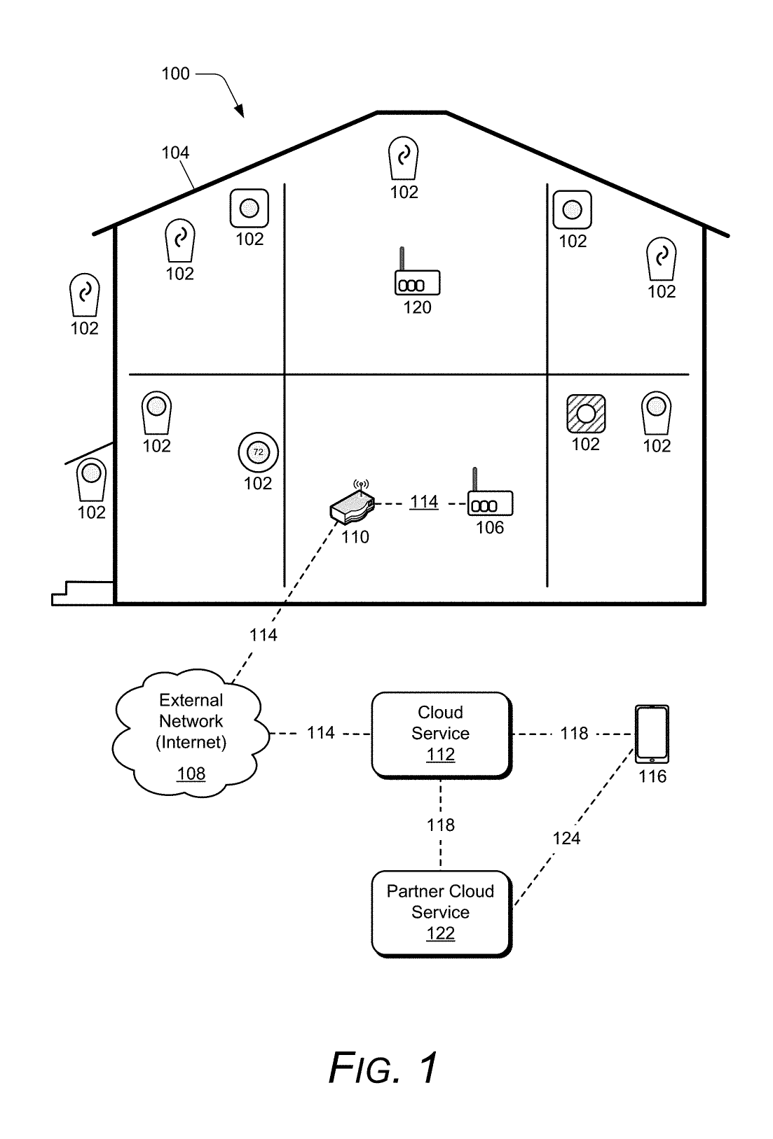

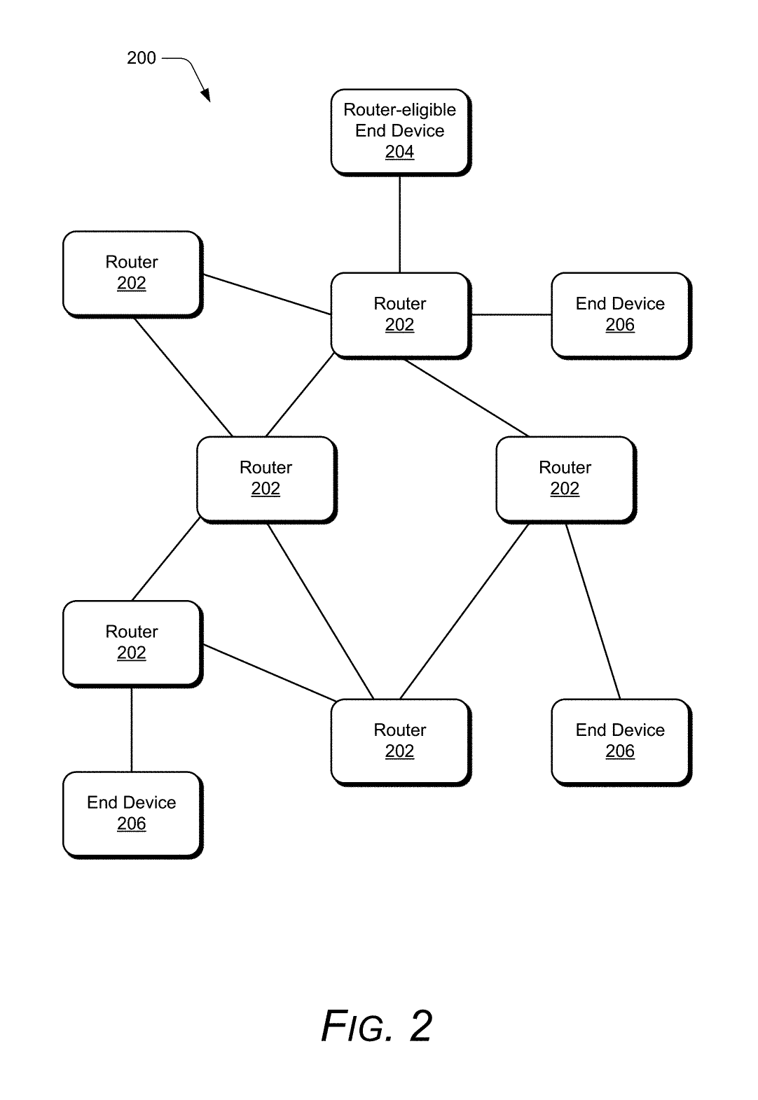

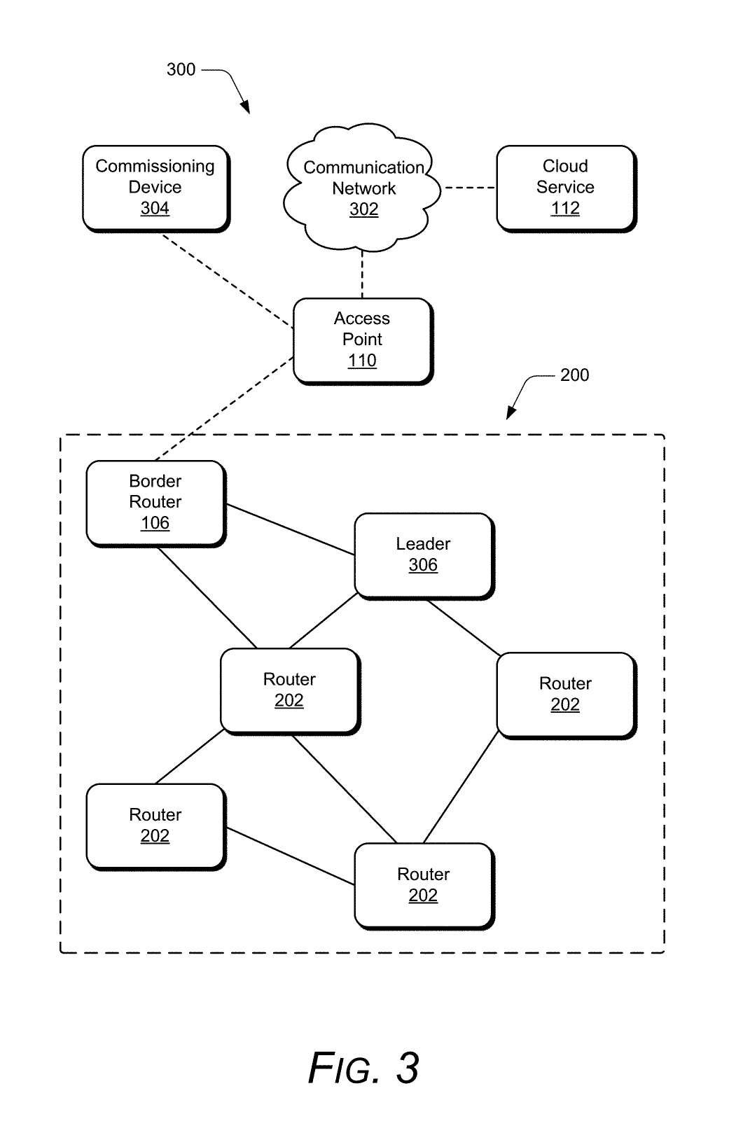

FIG. 1 illustrates an example distributed computing environment 100 in which aspects of multi-factor authentication via network-connected devices can be implemented. The distributed computing environment 100 (e.g., a fabric network) includes a home area network (HAN) such as a mesh network 200, described below with respect to FIGS. 2 and 3. The HAN includes mesh network devices 102 that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the mesh network devices 102 in the HAN, a cloud service 112 connects to the HAN via border router 106, via a secure tunnel 114 through the external network 108 and the access point 110. The cloud service 112 facilitates communication between the HAN and internet clients 116, such as apps on mobile devices, using a web-based application programming interface (API) 118. The cloud service 112 also manages a home graph that describes connections and relationships between the mesh network devices 102, elements of the structure 104, and users. The cloud service 112 also hosts controllers which orchestrate and arbitrate home automation experiences.

The mesh network devices 102, the cloud service 112, and the internet clients 116 collectively communicate in a fabric network that includes one or more logical networks to manage communication between the devices and services. The fabric network is described in U.S. patent application Ser. No. 13/926,302 entitled “Fabric Network” filed Jun. 25, 2013, the disclosure of which is incorporated by reference herein in its entirety.

The HAN may include one or more mesh network devices 102 that function as a hub 120. The hub 120 may be a general-purpose home automation hub, or an application-specific hub, such as a security hub, an energy management hub, an HVAC hub, and so forth. The functionality of a hub 120 may also be integrated into any mesh network device 102, such as a smart thermostat device, a smart speaker, or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between mesh network devices 102.

The mesh network devices 102 in the HAN may be from a single manufacturer that provides the cloud service 112 as well, or the HAN may include mesh network devices 102 from partners. These partners may also provide partner cloud services 122 that provide services related to their mesh network devices 102 through a partner Web API 124. The partner cloud service 122 may optionally or additionally provide services to internet clients 116 via the web-based API 118, the cloud service 112, and the secure tunnel 114.

The distributed computing environment 100 can be implemented on a variety of hosts, such as battery-powered microcontroller-based devices, line-powered devices, and servers hosting cloud services. Protocols operating in the mesh network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

FIG. 2 illustrates an example mesh network 200 that implements the HAN in the distributed computing environment 100. The mesh network 200 is a wireless mesh network that includes routers 202, a router-eligible end device 204, and end devices 206. The routers 202, the router-eligible end device 204, and the end devices 206, each include a mesh network interface for communication over the mesh network. The routers 202 receive and transmit packet data over the mesh network interface. The routers 202 also route traffic across the mesh network 200. The routers 202 and the router-eligible end devices 204 can assume various roles, and combinations of roles, within the mesh network 200, as discussed below.

The router-eligible end devices 204 are located at leaf nodes of the mesh network topology and are not actively routing traffic to other nodes in the mesh network 200. The router-eligible device 204 is capable of becoming a router 202 when the router-eligible device 204 is connected to additional devices. The end devices 206 are devices that can communicate using the mesh network 200, but lack the capability, beyond simply forwarding to its parent router 202, to route traffic in the mesh network 200. For example, a battery-powered sensor is one type of end device 206.

The routers 202, the router-eligible end device 204, and the end devices 206 include network credentials that are used to authenticate the identity of these devices as being a member of the mesh network 200. The routers 202, the router-eligible end device 204, and the end devices 206 also use the network credentials to encrypt communications in the mesh network.

During sleep periods, a child end device 206 that sleeps is not available on the mesh network 200 to receive data packets addressed to the child end device 206. The child end device 206 attaches to a parent router 202, which responds, on behalf of the child end device 206, to mesh network traffic addressed to the child end device 206.

The child end device 206 also depends on the parent router 202 to receive and store all data packets addressed to the child device 206, including commissioning datasets, which may be received while the child end device 206 is sleeping. When the child end device 206 awakes, the stored data packets are forwarded to the child end device 206. The parent router 202 responding on behalf of the sleeping child end 206 device ensures that traffic for the child end device 206 is handled efficiently and reliably on the mesh network 200, as the parent router 202 responds to messages sent to the child end device 206, which enables the child end device to operate in a low-power mode for extended periods of time to conserve power.

FIG. 3 illustrates an example environment 300 in which various aspects of multi-factor authentication via network-connected devices can be implemented. The environment 300 includes the mesh network 200 as shown and described with reference to FIG. 2, in which some routers 202 are performing specific roles in the mesh network 200. The devices within the mesh network 200, as illustrated by the dashed line, are communicating securely over the mesh network 200, using the network credentials.

The border router 106 (also known as a gateway and/or an edge router) is one of the routers 202. The border router 106 includes a second interface for communication with an external network, outside the mesh network 200. The border router 106 connects to an access point 110 over the external network. For example, the access point 110 may be an Ethernet router, a Wi-Fi access point, or any other suitable device for bridging different types of networks. The access point 110 connects to a communication network 302, such as the Internet. The cloud service 112, which is connected via the communication network 302, provides services related to and/or using the devices within the mesh network 200. By way of example, and not limitation, the cloud service 112 provides applications that include connecting end user devices (internet clients), such as smart phones, tablets, and the like, to devices in the mesh network 200, processing and presenting data acquired in the mesh network 200 to end users, linking devices in one or more mesh networks 200 to user accounts of the cloud service 112, provisioning and updating devices in the mesh network 200, and so forth.

A user choosing to commission and/or configure devices in the mesh network 200 uses a commissioning device 304, which connects to the border router 106 via the external network technology of the access point 110, to commission and/or configure the devices. The commissioning device 304 may be any computing device, such as a smart phone, tablet, notebook computer, and so forth, with a suitable user interface and communication capabilities to execute applications that control devices to the mesh network 200. Only a single commissioning device 304 may be active (i.e., an active commissioner) on the mesh network 200 at one time.

One of the routers 202 performs the role of a leader 306 for the mesh network 200. The leader 306 manages router identifier assignment and the leader 306 is the central arbiter of network configuration information for the mesh network 200. The leader 306 propagates the network configuration information to the other devices in the mesh network 200. The leader 306 also controls which commissioning device is accepted as a sole, active commissioner for the mesh network 200, at any given time.

Multi-Factor Authentication (MFA) can be implemented using a mixture of factors, such as a knowledge factor, a possession factor, and an inherence factor. The knowledge factor represents one or more pieces of information that a user knows, such as passwords, pin codes, security questions, and so forth. The possession factor is representative of an item that the user possesses, such as a mobile device, USB security key, debit card, and so forth. The inherence factor is representative of an inherent factor associated with the user, which is also known as a biometric factor, such as a fingerprint scan, a retina scan, voice recognition, facial recognition, and so forth.

Depending on their capabilities, devices that are connected to the distributed computing system 100 can function to present or provide any of these factors. For example, a keypad in a security system can be used to enter a temporary personal identification number (PIN) code to confirm identify. The cloud service 112 sends a device of a user a one-time PIN (knowledge factor) and in turn, the user enters the one-time PIN code into the security keypad at home (possession factor).

In another aspect, a user can generate a pre-selected combination of a code word (knowledge factor) and a matching device (possession factor). When authentication is required or requested, the cloud service 112 prompts the user with the code word and the user responds by interacting with the matching device. For example, a user may choose the code word “Seattle” and select the device “Hallway Light.” When the cloud service 112 needs a higher degree of confidence in the user's identity, the cloud service 112 prompts the user with the code word “Seattle” and the user knows to interact with the device known to the user and to the cloud service 112 as “Hallway Light” (e.g., the device is a light switch that controls a light in the hallway of the home).

In another aspect, an inherent factor is associated with the matching device. The inherent factor may include voice recognition or facial recognition. For example, the cloud service 112 prompts the user to stand in front of a specific camera, such as a “Living Room Camera” for facial recognition or the cloud service 112 prompts the user to speak a pass phrase into a specific smart speaker, such as a “Kitchen Speaker.”

In another aspect, devices that are connected to the distributed computing system 100, such as home automation devices, can provide a new layer of security and authentication that does not currently exist. These network-connected devices, which are continuously monitored by a service, such as the cloud service 112, increase security and privacy based on observed user interactions with these securely connected devices and internet clients 116 that interact with the cloud service 112. Patterns of user interactions that are observed over time are used to train a model of typical behavior or behavior patterns of the user, which provides a behavioral authentication factor. By comparing a set of monitored interactions with the behavioral authentication factor, both normal scenarios, which authenticate a known user, and anomalous scenarios are identified.

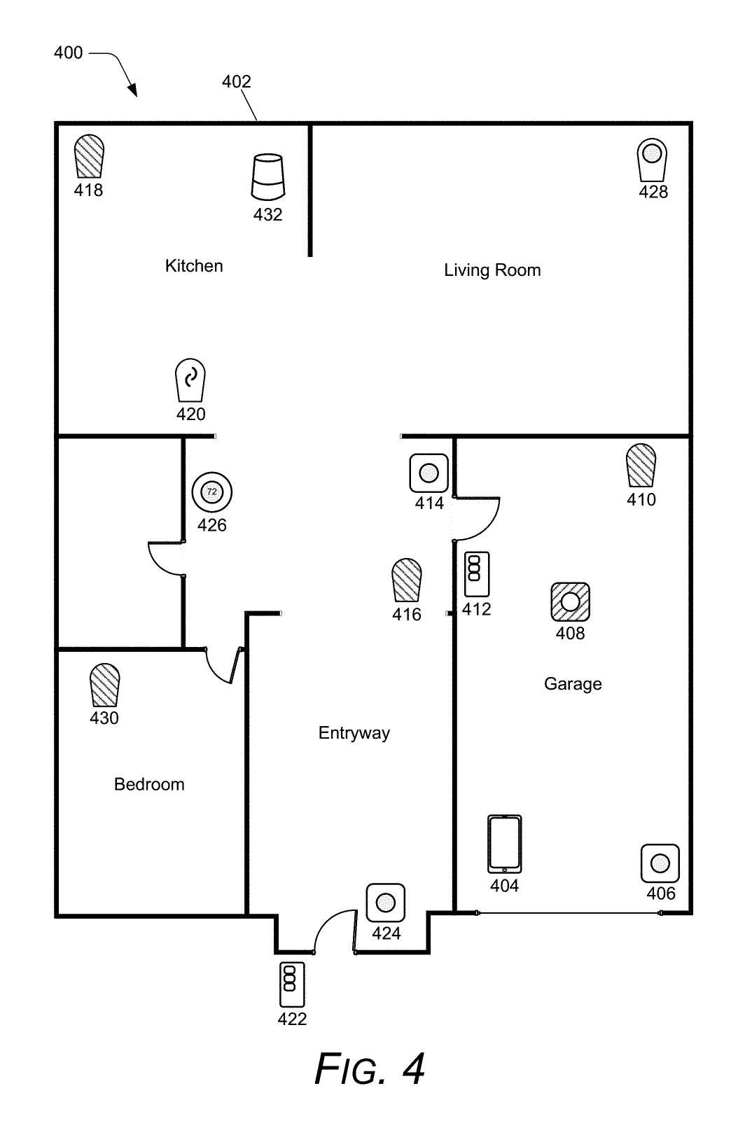

FIG. 4 illustrates an example environment 400 for multi-factor authentication via network-connected devices. The environment 400 shows the floorplan of a structure 402, such as a house or other type of building, in which a variety of sensor and controller devices are installed. The devices illustrated in environment 400 are connected via external network 108, and monitored via cloud service 112, as described and illustrated in FIG. 1. The additional network devices and connections associated with monitoring the sensor and controller devices in the environment 400 are omitted for clarity of illustration.

In one aspect, various scenarios of interactions with the devices by a user in the structure 402 may be observed and used to train a model behavioral authentication factor. As more interactions by the user with the devices are observed over a period of time (to include days, weeks, etc.), a confidence level of the identity of the user increases. For example, a typical scenario for a user arriving home includes a series of interactions with network-connected devices and/or mobile devices in the environment 400. In this scenario, the user may park a car in the garage, enter the house, and turn on a light in the entryway. The period of time over which these interactive actions occur, the rate at which the interactions are detected, and/or the days of the week and time of the days at which the interactions are detected can also be used to train the model behavioral authentication factor.

For example, an arrival begins when a mobile device 404 of the user is detected in or near the structure 402, such as the mobile device 404, acting as an internet client 116, crossing a geo-fence boundary or connecting to a home Wi-Fi network. Alternatively or additionally, the user's automobile is detected entering the garage, such as by detecting the garage door opening and/or closing by a security sensor 406, a garage door opener 408, and/or an occupancy sensor 410. The user's automobile may also be an Internet client connecting to the home Wi-Fi network as the automobile enters the garage. The entry of the user is detected when the user unlocks a lock 412, opens the door into the entryway as detected by a security sensor 414, and/or motion of the user's entry is detected by a motion sensor 416. As the user walks into the kitchen, the user's motion is detected by motion sensor 418 as the user turns the lighting controller 420 to “ON” to turn on the kitchen lights.

The previous example is only one scenario of many scenarios that can be learned to determine behavioral authentication factors. For example, entry into the structure 402 may be indicated by unlocking the front door with a door lock 422 and detecting the front door opening by security sensor 424. Motion may be detected by various devices in addition to occupancy/motion sensors, including a smart thermostat 426 or a camera 428.

In another aspect, motion sensors that use ultrasonic and/or radar sensing determine range or distance to the user, sense user gestures, and sense user characteristics, such as size and/or height as an inherent authentication factor. Additionally or alternatively, these motion sensors map patterns of movement of the user among locations within the structure 402. These sensed patterns can be used as behavioral authentication factors to authenticate the user.

Other information related to user behaviors and patterns, and in the structure 402 in the environment 400 may also be used for training and using models for behavioral authentication factors. By way of example, and not limitation, the other information includes events scheduled on users' calendars, scheduled HVAC control modes, locations and/or directions of travel based on users' mobile devices 404, information provided by resources associated with the structure 402 that are abstracted from information provided by devices and/or web services, and so forth.

Once training has raised the confidence level of the model behavioral authentication factor to a sufficiently high level, the model can be used as an authentication factor in authenticating a user, as well as detecting questionable and/or anomalous scenarios that are not a sufficient match to any learned scenario. Detection of a questionable or anomalous scenario may trigger a request for further authentication information from a user, trigger notification of registered users of detection of the activity, and so forth.

For example, consider a scenario where the security sensor 424 detects that the front door is opened without being unlocked using the door lock 422. Then motion is detected in a rapid sequence by the entryway motion sensor 416, a bedroom motion sensor 430, and the kitchen motion sensor 418, along with rapid changes in light levels detected by the camera 428. This detected scenario does not match any learned scenario and may indicate a break-in to the structure 402. Additionally, other information may be factored into a determination, such as no car being detected in the garage, the pattern of motion not matching any learned patterns of motion, and/or no known user devices indicated as being in or near the structure 402.

In another aspect, interactions with the devices in the environment 400 may be used to authenticate the user to a service or an organization. The knowledge of devices in the structure 402 that is shared between the user and the cloud service 112 can act as a knowledge factor and a possession factor in authenticating a user and validating that the user is in the structure 402. Additionally, an inherent factor, such as voice recognition or facial recognition, can be associated with a specific device to authenticate the user.

By way of example and not limitation, a user can be authenticated during a customer support exchange, such as a call, chat session, and/or email exchange to address an issue for the user. An agent that provides service can verify the identity of the user by requesting information to identify the user, which may include using security questions to verify the identity of the user. Alternately or additionally, the user may be authenticated by interacting with a network-connected device in the structure 402. The network-connected device may be a device predetermined to be a security device, in which case the agent asks the user to interact with the security device but does not identify the security device to the user. The cloud service 112, which monitors the devices in the structure 402, indicates the interaction and/or that the interaction is the correct interaction to the agent, thus authenticating the identity of the user and verifying that the user is in the structure 402. Alternatively, if the agent only seeks to verify that the user is in the structure 402, the agent can specify a device with which the user will interact, such as the agent asking the user to turn the kitchen light off and on using the lighting controller 420, to stand in front of the living room camera 428 for facial recognition, or to speak a pass phrase into the kitchen smart speaker 432.

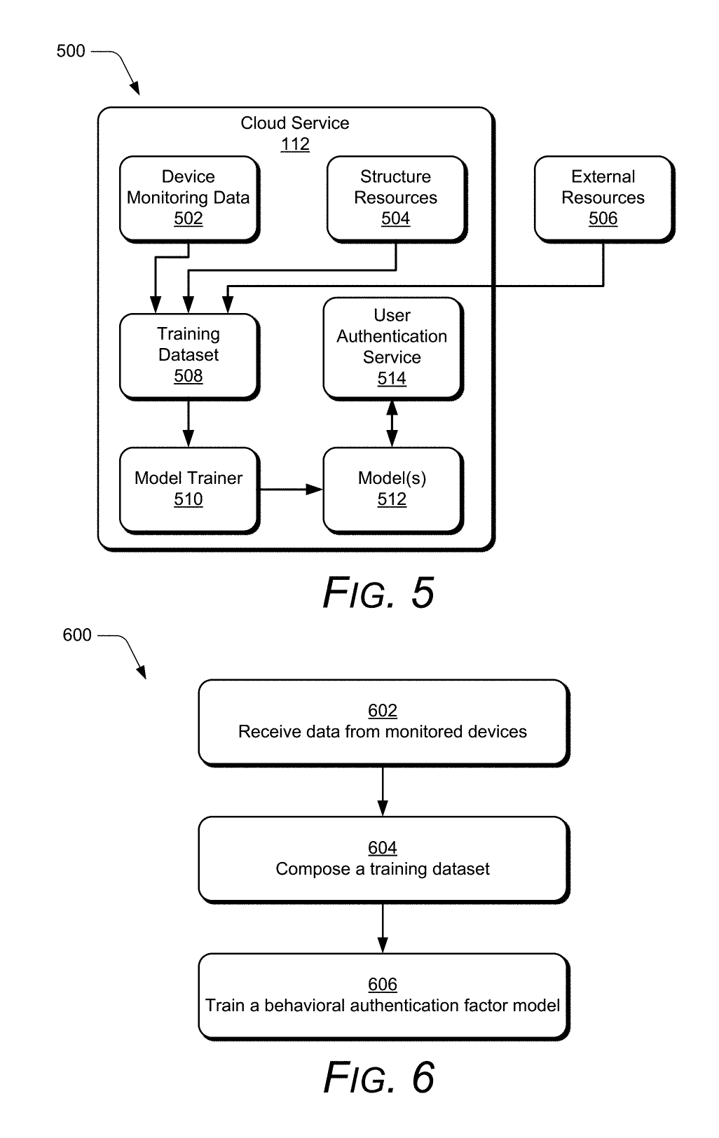

FIG. 5 illustrates an example behavioral factor authentication system 500 for multi-factor authentication via network-connected devices. The behavioral factor authentication system 500 uses data from one or more sources to train models for behavioral authentication factors. The sources of training data include device monitoring data 502, structure resources data 504, and/or external resources data 506. The device monitoring data 502 is data received from the devices illustrated in FIGS. 1, 4, and 9, which are continuously monitored by the cloud service 112 to provide services to the user, such as home automation services, security services, and so forth. The structure resources data 504 provide data that includes aggregations of traits of various devices in the structure 402 that are useful in providing services, information related to users and user accounts that are associated with various services provided in relation to the structure 402, a home graph that describes connections and relationships between the network-connected devices, elements of the structure 402, and users, and the like. Data from the external resources data 506 includes data from the partner cloud services 122, calendaring services, email services, news services, weather services, location-based services for mobile devices, voice-assistants, and so forth.

The device monitoring data 502, the structure resources data 504, and/or the external resources data 506 are included in a training dataset 508. The training dataset 508 is provided to a model trainer 510 that applies machine learning techniques to produce one or more models 512 that are usable to provide behavioral authentication factors for multi-factor authentication, based on user interactions with the network-connected devices in the environment 400.

In one aspect, a user authentication service 514 compares user activities, which are monitored by the network-connected devices and the cloud service 112, to patterns of user activities of the model(s) 512 to authenticate a user based on a behavioral authentication factor. The user authentication service 514 determines a confidence level that a pattern of user behavior matches the behavioral authentication factor. The value of the confidence level is evaluated by the user authentication service 514 to determine if the value of the confidence level is high enough to authenticate the user identity.

In another aspect, the user authentication service 514 authenticates a user based on the user interacting with a network-connected device. For example, the user authentication service 514 receives an indication of an identity of a user, such as from login credentials supplied by a user when logging into an account on the cloud service 112. The user authentication service 514 determines a network-connected device for a user interaction that will be used to authenticate the identity of the user. The network-connected device for the interaction may be either a predetermined device known to the user and the user authentication service 514, or the user authentication service 514 may select a device from the set of network-connected devices associated with the user account on the cloud service 112. The user authentication service 514, or a representative interacting with the user, indicates to the user to interact with the network-connected device. The user interaction can be active (e.g., the users switches a light switch) or passive (e.g., the user walks past a motion sensor so that motion is detected). If the user authentication service 514 receives the expected user interaction, this indication authenticates the user and authenticates that the user has legitimate access to network-connected devices in the structure 402 that is associated with the user's account.

Although the device monitoring data 502, the structure resources data 504, the training dataset 508, the model trainer 510, the models 512, and the user authentication service 514 are illustrated as included in the cloud service 112, the various blocks illustrated in the behavioral factor authentication system 500 may be distributed in any suitable fashion. For example, the device monitoring data 502 and the structure resources data 504 may be hosted in the cloud service 112, the hub 120, the border router 106, the partner cloud service 122, or any combination thereof. The training dataset 508, the model trainer 510, the models 512, and the user authentication system 514 may be hosted in the cloud service 112, the hub 120, the border router 106, a web-based authentication service communicatively coupled to the cloud service 112, or any combination thereof. For example, by hosting the models 512 and the user authentication system 514 locally, in the hub 120 of a security system for the structure 402, user authentication and anomaly detection can be provided with lower latency and higher reliability by removing dependence on an internet connection to a web-based service.

The model trainer 510 can use any suitable machine learning technique(s), learning algorithm(s), decision tree(s), classifier(s), and the like, as are well known in the art. The model trainer 510 and the user authentication service 514 can be implemented using any suitable computing or processing device, such as those described in FIG. 11. The model trainer 510 may use batch training, on-line training, or any suitable combination. The models 512 may continue to be further trained by the model trainer 510 after the models have reached a suitable confidence level for deployment and after the models 512 have been deployed for use in multi-factor authentication.

Example methods 600, 700, and 800 are described with reference to respective FIGS. 6, 7, and 8 in accordance with one or more aspects of multi-factor authentication via network-connected devices. Generally, any of the components, modules, methods, and operations described herein can be implemented using software, firmware, hardware (e.g., fixed logic circuitry), manual processing, or any combination thereof. Some operations of the example method may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates example method(s) 600 of multi-factor authentication via network-connected devices as generally related to training models for behavioral authentication factors in the distributed computing system 100 and the behavioral factor authentication system 500. The order in which the method blocks are described are not intended to be construed as a limitation, and any number of the described method blocks can be combined in any order to implement a method, or an alternate method.

At block 602, a behavioral factor authentication system receives data from network-connected devices that are monitored, the data describing sensor readings, control commands, and/or user interactions with network-connected devices. For example, the behavioral factor authentication system 500 receives the device monitoring data 502 that describes sensor readings, control commands, and/or user interactions from mesh network devices 102 that are monitored by the cloud service 112 and/or the hub 120.

At block 604, the behavioral factor authentication system composes a training dataset from the received device monitoring data, structure resources, and/or external resources. For example, the behavioral factor authentication system 500 composes the training dataset 508 from the device monitoring data 502, the structure resources data 504, and/or external resources data 506. The composition of the training dataset 508 may include querying and/or correlating device monitoring data 502 with events and/or data from the structure resources data 504 and/or the external resources data 506.

At block 606, the behavioral factor authentication system trains a behavioral authentication factor model using the training dataset. For example, the model trainer 510 applies suitable machine learning technique(s), learning algorithm(s), decision tree(s), classifier(s), and the like, to train the model 512 to produce a behavioral authentication factor model from the training dataset 508.

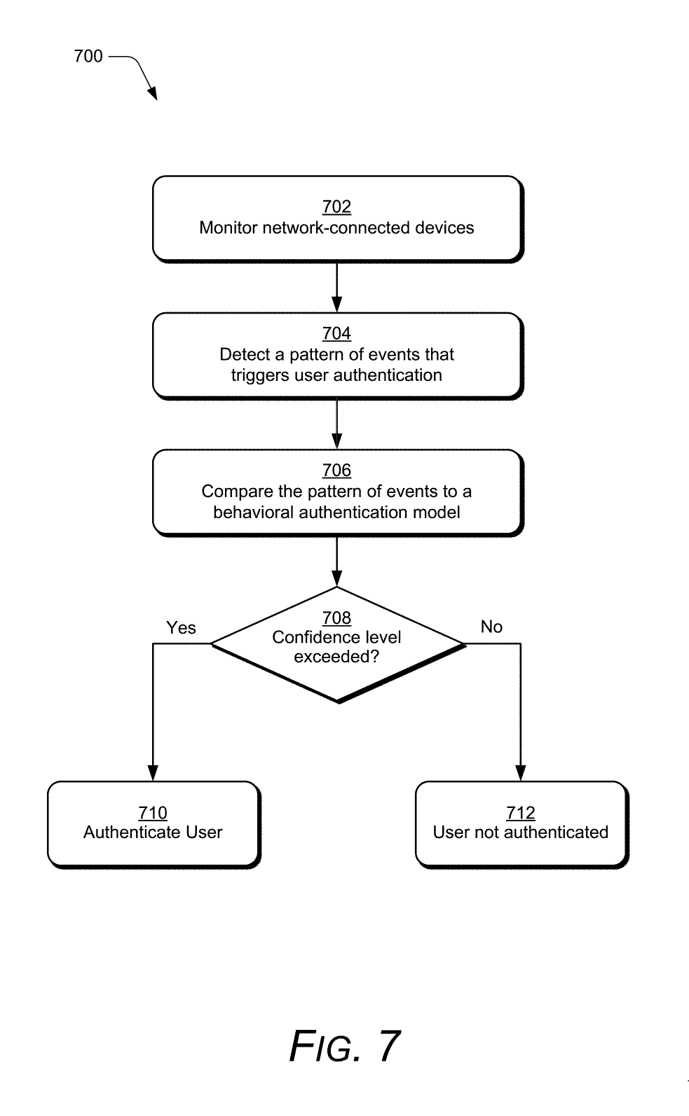

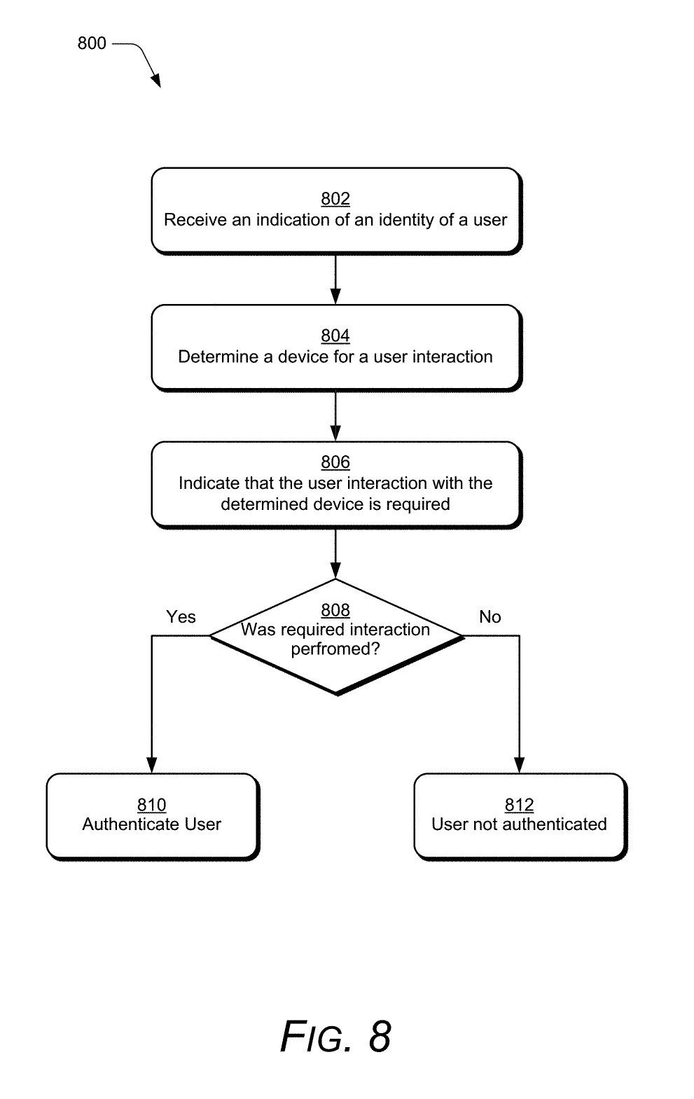

FIG. 7 illustrates example method(s) 700 of multi-factor authentication via network-connected devices as generally related to authenticating a user using a model for a behavioral authentication factor in the distributed computing system 100. The order in which the method blocks are described are not intended to be construed as a limitation, and any number of the described method blocks can be combined in any order to implement a method, or an alternate method.

At block 702, a user authentication service monitors network-connected devices, including receiving sensor readings, control commands, and/or user interactions with network-connected devices and/or mobile devices. For example, the cloud service 112 monitors the mesh network devices 102 and the mobile devices 404, and receives data indicative of sensor readings in the environment 400, location data for users, and/or events such as a mobile device crossing a geo-fence boundary.

At block 704, the user authentication service detects a pattern of events in the monitored data that triggers a user authentication. For example, the behavioral factor authentication system 500 detects a pattern of events from monitored devices in the environment 400 that trigger authentication of a user. The pattern of events may include a mobile device 404 of the user crossing a geo-fence boundary and/or sensor data being received from mesh network devices 102 that indicate activity in the structure 402. Based on the detected pattern of events, the behavioral factor authentication system 500 determines that authentication of the user based on a behavioral authentication factor is required.

At block 706, the user authentication service compares the detected pattern of events to a behavioral authentication factor to produce a confidence level for the identity of the user. For example, the user authentication service 514 compares the detected pattern of events to one or more behavioral factor authentication models 512 to determine a confidence level associated with the identity of the user.

At block 708, the user authentication service determines if the confidence level for the user identity is sufficiently high to authenticate the user. At block 710, the user authentication service provides an indication that the identity of the user is authenticated. For example, the user authentication service 514 compares the determined confidence level to a threshold value for authentication. If the confidence level exceeds the threshold value for authentication, the user authentication service 514 authenticates the user.

Alternatively, at block 712, if the confidence level for the user identity is not sufficiently high to authenticate the user, the user authentication service provides an indication that the identity of the user is not authenticated. For example, if the confidence level does not exceed the threshold value for authentication, the user authentication service 514 provides an indication that the user is not authenticated.

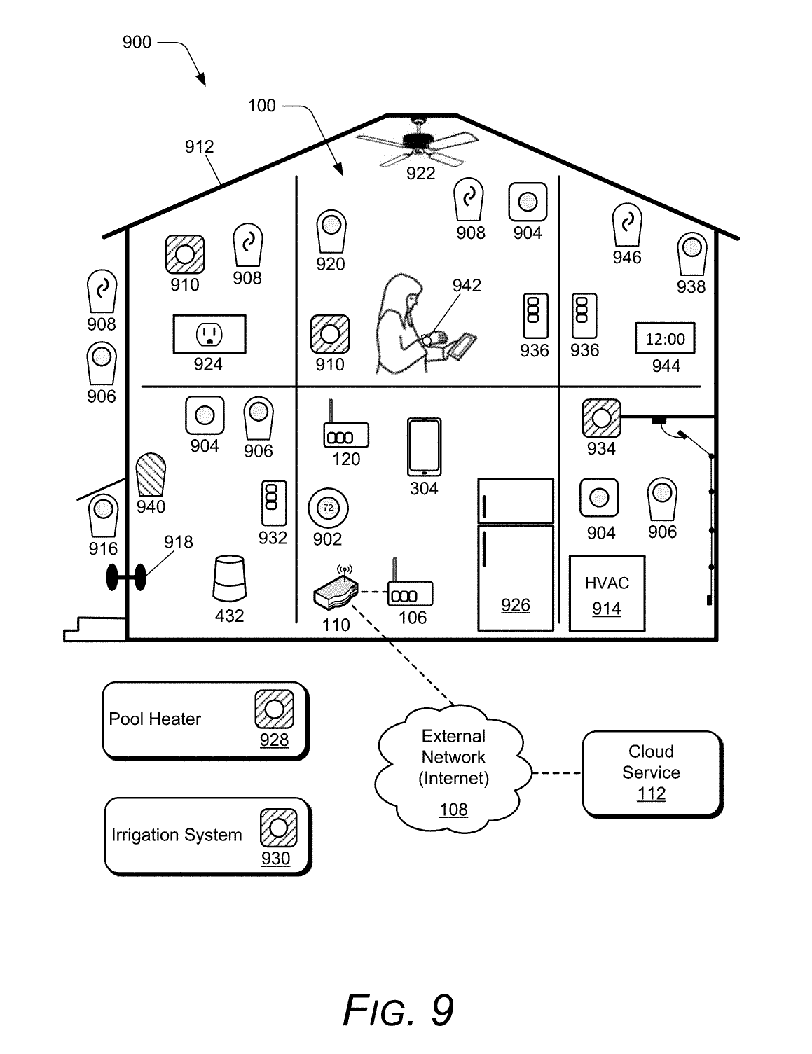

FIG. 8 illustrates example method(s) 800 of multi-factor authentication via network-connected devices as generally related to authenticating a user based on interaction with a device in the distributed computing system 100. The order in which the method blocks are described are not intended to be construed as a limitation, and any number of the described method blocks can be combined in any order to implement a method, or an alternate method.

At block 802, a user authentication service receives an indication of an identity of a user. For example, the user authentication service 514 receives an indication of an identity of a user, such as a username associated with a user account for the cloud service 112.

At block 804, the user authentication service determines a device for a user interaction. For example, the user authentication service 514 determines which device of the network-connected devices in the structure 402 will be the device used for an interaction with the user. The determined device may be a predetermined device designated for authentication interactions with the user or may be any device the user authentication system 514 chooses from a set of network-connected devices associated with the structure 402.

At block 806, the user authentication service indicates to the user that an interaction with the determined device is required and optionally, may indicate what type of interaction is expected from the user. For example, in the case of the predetermined device, the user authentication service 514 indicates to the user to interact with the predetermined device. In the case where the user authentication service 514 determines which device of the network-connected devices in the structure 402 will be the device used for the interaction, the user authentication service 514 indicates to the user which device to interact with, and optionally what type of interaction is expected, such as “turn the kitchen light on and off;” “speak the pass phrase into the kitchen smart speaker,” or “stand in front of the living room camera for facial recognition.” The indication from the user authentication system may be conveyed directly to the user, such as via a web page, a mobile app, and/or chat message, or in the case of a telephone interaction, the indication may be presented to a support representative for the cloud service 112, who in turn conveys the required interaction to the user.

At block 808, the user authentication service determines if the required user interaction was performed. At block 810, if the user interaction was performed, the user authentication service provides an indication that the identity of the user is authenticated. For example, the user authentication service 514 determines if the cloud service 112 has received an indication, such as a status message or sensor data from the designated device, which indicates that the user performed the required interaction. If the required interaction was performed, the user authentication service 514 authenticates the user as being authorized to access the structure and services related to the structure.

Alternatively, at block 812, if the required interaction was not performed, the user authentication service provides an indication that the identity of the user is not authenticated. For example, if the required interaction was not performed, the user authentication service 514 provides an indication that the user is not authenticated.

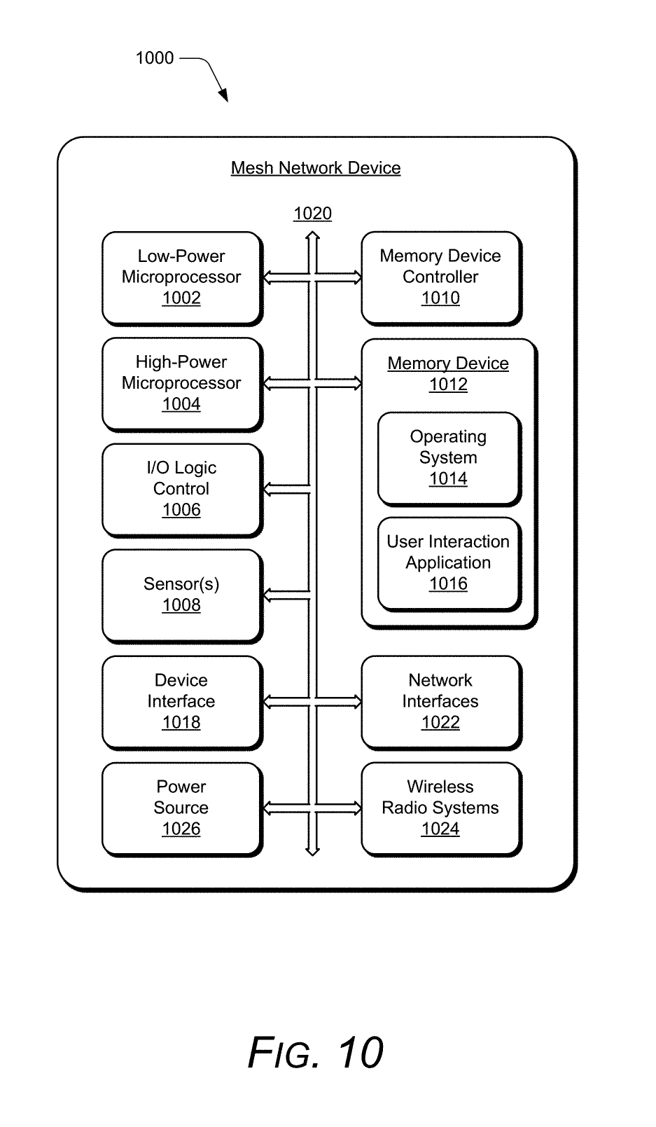

FIG. 9 illustrates an example environment 900 in which the mesh network 100 (as described with reference to FIG. 1), and aspects of multi-factor authentication via network-connected devices can be implemented. Generally, the environment 900 includes the distributed computing system 100 implemented as part of a smart-home or other type of structure with any number of mesh network devices that are configured for communication in a mesh network. For example, the mesh network devices can include a thermostat 902, hazard detectors 904 (e.g., for smoke and/or carbon monoxide), cameras 906 (e.g., indoor and outdoor), lighting units 908 (e.g., indoor and outdoor), and any other types of mesh network devices 910 that are implemented inside and/or outside of a structure 912 (e.g., in a smart-home environment). In this example, the mesh network devices can also include any of the previously described devices, such as a border router 106, a leader device 306, a commissioning device 304, a hub device 120, a smart speaker 432 that provides voice assistant services, as well as any of the devices implemented as a router 202, and/or an end device 206.

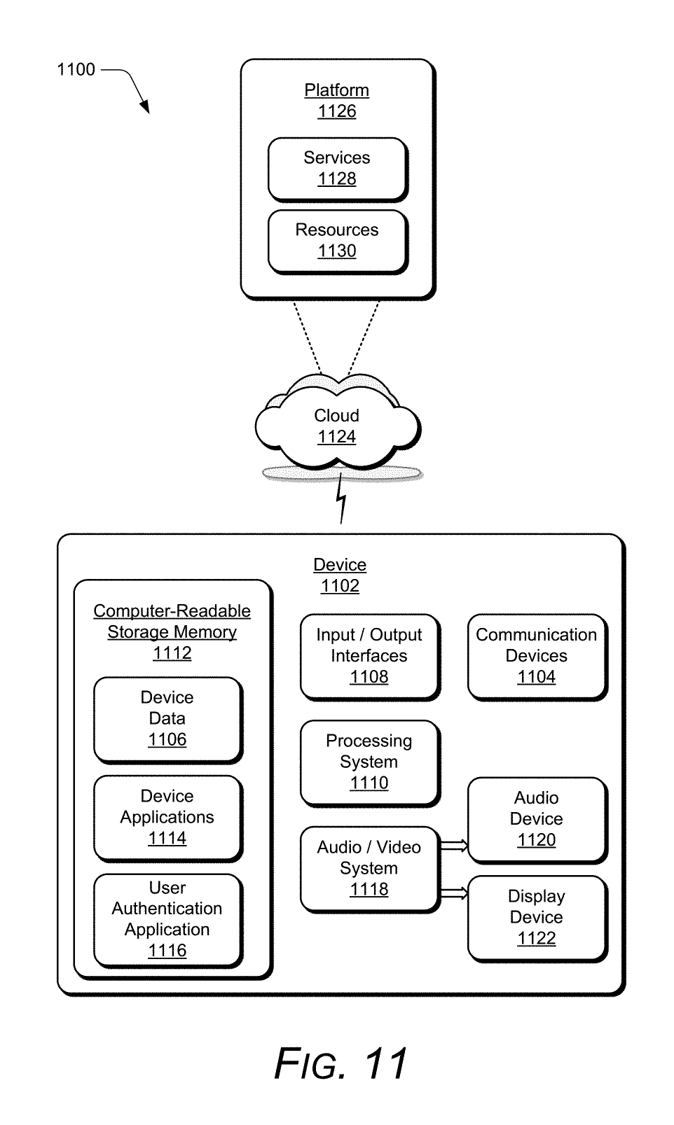

In the environment 900, any number of the mesh network devices can be implemented for wireless interconnection to wirelessly communicate and interact with each other. The mesh network devices are modular, intelligent, multi-sensing, network-connected devices that can integrate seamlessly with each other and/or with a central server or a cloud-computing system to provide any of a variety of useful smart-home objectives and implementations. An example of a mesh network device that can be implemented as any of the devices described herein is shown and described with reference to FIG. 10.

In implementations, the thermostat 902 may include a Nest® Learning Thermostat that detects ambient climate characteristics (e.g., temperature and/or humidity) and controls a HVAC system 914 in the smart-home environment. The learning thermostat 902 and other smart devices “learn” by capturing occupant settings to the devices. For example, the thermostat learns preferred temperature set-points for mornings and evenings, and when the occupants of the structure are asleep or awake, as well as when the occupants are typically away or at home.

A hazard detector 904 can be implemented to detect the presence of a hazardous substance or a substance indicative of a hazardous substance (e.g., smoke, fire, or carbon monoxide). In examples of wireless interconnection, a hazard detector 904 may detect the presence of smoke, indicating a fire in the structure, in which case the hazard detector that first detects the smoke can broadcast a low-power wake-up signal to all of the connected mesh network devices. The other hazard detectors 904 can then receive the broadcast wake-up signal and initiate a high-power state for hazard detection and to receive wireless communications of alert messages. Further, the lighting units 908 can receive the broadcast wake-up signal and activate in the region of the detected hazard to illuminate and identify the problem area. In another example, the lighting units 908 may activate in one illumination color to indicate a problem area or region in the structure, such as for a detected fire or break-in, and activate in a different illumination color to indicate safe regions and/or escape routes out of the structure.

In various configurations, the mesh network devices 910 can include an entryway interface device 916 that functions in coordination with a network-connected door lock system 918, and that detects and responds to a person's approach to or departure from a location, such as an outer door of the structure 912. The entryway interface device 916 can interact with the other mesh network devices based on whether someone has approached or entered the smart-home environment. An entryway interface device 916 can control doorbell functionality, announce the approach or departure of a person via audio or visual means, and control settings on a security system, such as to activate or deactivate the security system when occupants come and go. The mesh network devices 910 can also include other sensors and detectors, such as to detect ambient lighting conditions, detect room-occupancy states (e.g., with an occupancy sensor 920), detect user characteristics, detect patterns of user motion about the structure 912, and control a power and/or dim state of one or more lights. In some instances, the sensors and/or detectors may also control a power state or speed of a fan, such as a ceiling fan 922. Further, the sensors and/or detectors may detect occupancy in a room or enclosure and control the supply of power to electrical outlets or devices 924, such as if a room or the structure is unoccupied.

The mesh network devices 910 may also include connected appliances and/or controlled systems 926, such as refrigerators, stoves and ovens, washers, dryers, air conditioners, pool heaters 928, irrigation systems 930, security systems 932, and so forth, as well as other electronic and computing devices, such as televisions, entertainment systems, computers, intercom systems, garage-door openers 934, ceiling fans 922, control panels 936, and the like. When plugged in, an appliance, device, or system can announce itself to the mesh network as described above and can be automatically integrated with the controls and devices of the mesh network, such as in the smart-home. It should be noted that the mesh network devices 910 may include devices physically located outside of the structure, but within wireless communication range, such as a device controlling a swimming pool heater 928 or an irrigation system 930.

As described above, the mesh network 200 includes a border router 106 that interfaces for communication with an external network 108, outside the mesh network 200. The border router 106 connects to an access point 110, which connects to the external communication network 108, such as the Internet. A cloud service 112, which is connected via the external communication network 108, provides services related to and/or using the devices within the mesh network 200. By way of example, the cloud service 112 can include applications for the commissioning device 304, such as smart phones, tablets, and the like, to devices in the mesh network, processing and presenting data acquired in the mesh network 200 to end users, linking devices in one or more mesh networks 200 to user accounts of the cloud service 112, provisioning and updating devices in the mesh network 200, and so forth. For example, a user can control the thermostat 902 and other mesh network devices in the smart-home environment using a network-connected computer or portable device, such as a mobile phone or tablet device. Further, the mesh network devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Bluetooth Low Energy, etc.) and/or by using any of a variety of custom or standard wired protocols (CAT6 Ethernet, HomePlug, etc.).

Any of the mesh network devices in the mesh network 200 can serve as low-power and communication nodes to create the mesh network 200 in the smart-home environment. Individual low-power nodes of the network can regularly send out messages regarding what they are sensing, and the other low-powered nodes in the environment—in addition to sending out their own messages—can repeat the messages, thereby communicating the messages from node to node (i.e., from device to device) throughout the mesh network. The mesh network devices can be implemented to conserve power, particularly when battery-powered, utilizing low-powered communication protocols to receive the messages, translate the messages to other communication protocols, and send the translated messages to other nodes and/or to a central server or cloud-computing system. For example, an occupancy and/or ambient light sensor can detect an occupant in a room as well as measure the ambient light and activate the light source when the ambient light sensor 938 detects that the room is dark and when the occupancy sensor 920 detects that someone is in the room. Further, the sensor can include a low-power wireless communication chip (e.g., a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the mesh network, from node to node (i.e., smart device to smart device) within the smart-home environment as well as over the Internet to a central server or cloud-computing system.

In other configurations, various ones of the mesh network devices can function as “tripwires” for a security system in the smart-home environment. For example, in the event a perpetrator circumvents detection by security sensors 940 located at windows, doors, and other entry points of the structure or environment, an alarm could still be triggered by receiving an occupancy, motion, heat, sound, etc. message from one or more of the low-powered mesh nodes in the mesh network. In other implementations, the mesh network can be used to automatically turn on and off the lighting units 908 as a person transitions from room to room in the structure. For example, the mesh network devices can detect the person's movement through the structure and communicate corresponding messages via the nodes of the mesh network. Using the messages that indicate which rooms are occupied, other mesh network devices that receive the messages can activate and/or deactivate accordingly. As referred to above, the mesh network can also be utilized to provide exit lighting in the event of an emergency, such as by turning on the appropriate lighting units 908 that lead to a safe exit. The light units 908 may also be turned-on to indicate the direction along an exit route that a person should travel to safely exit the structure.

The various mesh network devices may also be implemented to integrate and communicate with wearable computing devices 942, such as may be used to identify and locate an occupant of the structure, and adjust the temperature, lighting, sound system, and the like accordingly. In other implementations, RFID sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, radar techniques, and infrared or near-field communication (NFC) techniques (e.g., a person wearing an infrared or NFC-capable smartphone), along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other mesh network devices and sensors in the environment according to rules-based inferencing techniques or artificial intelligence techniques for achieving better performance of these functionalities. In an example relating to a personal health-area, the system can detect whether a household pet is moving toward the current location of an occupant (e.g., using any of the mesh network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the mesh network, conforming to the wireless interconnection protocols for communicating on the mesh network.

The mesh network devices 910 may also include a smart alarm clock 944 for each of the individual occupants of the structure in the smart-home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the mesh network based on a unique signature of the person, which is determined based on data obtained from sensors located in the mesh network devices, such as sensors that include ultrasonic sensors, radar sensors, passive IR sensors, and the like. The unique signature of an occupant can be based on a combination of patterns of movement, voice, height, size, etc., as well as using facial recognition techniques.

The mesh network devices 910 may also include a motion sensor 946 that in addition to sensing occupancy, senses user motion paths, distance from the user to the motion sensor 946, user gestures, and/or user characteristics, such as height, shape, and/or size. The motion sensor 946 can also sense physiological functions of the user, such as heart beats and/or respiration. For example, the motion sensor 946 is mounted in a bedroom and can sense lung movement to monitor the respiration of a sleeping user to detect sleep apnea.

In an example of wireless interconnection, the wake time for an individual can be associated with the thermostat 902 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other mesh network devices can use the data to provide other smart-home objectives, such as adjusting the thermostat 902 so as to pre-heat or cool the environment to a desired setting and turning-on or turning-off the lights 908.

In implementations, the mesh network devices can also be utilized for sound, vibration, and/or motion sensing such as to detect running water and determine inferences about water usage in a smart-home environment based on algorithms and mapping of the water usage and consumption. This can be used to determine a signature or fingerprint of each water source in the home and is also referred to as “audio fingerprinting water usage.” Similarly, the mesh network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

FIG. 10 illustrates an example mesh network device 1000 that can be implemented as any of the mesh network devices in a mesh network in accordance with one or more implementations of multi-factor authentication via network-connected devices as described herein. The device 1000 can be integrated with electronic circuitry, microprocessors, memory, input output (I/O) logic control, communication interfaces and components, as well as other hardware, firmware, and/or software to implement the device in a mesh network. Further, the mesh network device 1000 can be implemented with various components, such as with any number and combination of different components as further described with reference to the example device shown in FIG. 10.

In this example, the mesh network device 1000 includes a low-power microprocessor 1002 and a high-power microprocessor 1004 (e.g., microcontrollers or digital signal processors) that process executable instructions. The device also includes an input-output (I/O) logic control 1006 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively, or in addition, the device can be implemented with any one or combination of software, hardware, firmware, or fixed logic circuitry that may be implemented with processing and control circuits. The low-power microprocessor 1002 and the high-power microprocessor 1004 can also support one or more different device functionalities of the device. For example, the high-power microprocessor 1004 may execute computationally intensive operations, whereas the low-power microprocessor 1002 may manage less complex processes such as detecting a hazard or temperature from one or more sensors 1008. The low-power processor 1002 may also wake or initialize the high-power processor 1004 for computationally intensive processes.

The one or more sensors 1008 can be implemented to detect various properties such as acceleration, temperature, humidity, water, supplied power, proximity, distance, external motion, device motion, sound signals, ultrasound signals, light signals, fire, smoke, carbon monoxide, global-positioning-satellite (GPS) signals, radio-frequency (RF), other electromagnetic signals or fields, or the like. As such, the sensors 1008 may include any one or a combination of temperature sensors, humidity sensors, hazard-related sensors, other environmental sensors, accelerometers, microphones, ultrasonic sensors, radar sensors, optical sensors up to and including cameras (e.g., charged coupled-device or video cameras, active or passive radiation sensors, GPS receivers, and radio frequency identification detectors. In implementations, the mesh network device 1000 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or smart-operation objectives.

The mesh network device 1000 includes a memory device controller 1010 and a memory device 1012, such as any type of a nonvolatile memory and/or other suitable electronic data storage device. The mesh network device 1000 can also include various firmware and/or software, such as an operating system 1014 that is maintained as computer executable instructions by the memory and executed by a microprocessor. The device software may also include a user interaction application 1016 that implements aspects of multi-factor authentication via network-connected devices. The mesh network device 1000 also includes a device interface 1018 to interface with another device or peripheral component and includes an integrated data bus 1020 that couples the various components of the mesh network device for data communication between the components. The data bus in the mesh network device may also be implemented as anyone or a combination of different bus structures and/or bus architectures.

The device interface 1018 may receive input from a user and/or provide information to the user (e.g., as a user interface), and a received input can be used to determine a setting. The device interface 1018 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 1018 may also receive inputs from any number of peripherals, such as buttons, a keypad, a switch, a microphone, and an imager (e.g., a camera device).

The mesh network device 1000 can include network interfaces 1022, such as a mesh network interface for communication with other mesh network devices in a mesh network, and an external network interface for network communication, such as via the Internet. The mesh network device 1000 also includes wireless radio systems 1024 for wireless communication with other mesh network devices via the mesh network interface and for multiple, different wireless communications systems. The wireless radio systems 1024 may include Wi-Fi, Bluetooth™, Mobile Broadband, Bluetooth Low Energy (BLE), and/or point-to-point IEEE 802.15.4. Each of the different radio systems can include a radio device, antenna, and chipset that is implemented for a particular wireless communications technology. The mesh network device 1000 also includes a power source 1026, such as a battery and/or to connect the device to line voltage. An AC power source may also be used to charge the battery of the device.

FIG. 11 illustrates an example system 1100 that includes an example device 1102, which can be implemented as any of the mesh network devices, computing devices, and/or cloud-based services that implement aspects of multi-factor authentication via network-connected devices as described with reference to the previous FIGS. 1-10. The example device 1102 may be any type of computing device, client device, mobile phone, tablet, communication, entertainment, gaming, media playback, computer server, cloud-based server, mesh network device, and/or other type of device. Further, the example device 1102 may be implemented as any other type of mesh network device that is configured for communication on a mesh network, such as a thermostat, hazard detector, camera, light unit, commissioning device, router, border router, joiner router, joining device, end device, leader, access point, a hub, and/or other mesh network devices.

The device 1102 includes communication devices 1104 that enable wired and/or wireless communication of device data 1106, such as data that is communicated between the devices in a mesh network, data that is being received, data scheduled for broadcast, data packets of the data, data that is synched between the devices, etc. The device data can include any type of communication data, as well as audio, video, and/or image data that is generated by applications executing on the device. The communication devices 1104 can also include transceivers for cellular phone communication and/or for network data communication.

The device 1102 also includes input/output (I/O) interfaces 1108, such as data network interfaces that provide connection and/or communication links between the device, data networks (e.g., a mesh network, external network, etc.), and other devices. The I/O interfaces can be used to couple the device to any type of components, peripherals, and/or accessory devices. The I/O interfaces also include data input ports via which any type of data, media content, and/or inputs can be received, such as user inputs to the device, as well as any type of communication data, as well as audio, video, and/or image data received from any content and/or data source.

The device 1102 includes a processing system 1110 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 1102 may further include any type of a system bus or other data and command transfer system that couples the various components within the device. A system bus can include any one or combination of different bus structures and architectures, as well as control and data lines.

The device 1102 also includes computer-readable storage memory 1112, such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 1112 provides storage of the device data 1106 and various device applications 1114, such as an operating system that is maintained as a software application with the computer-readable storage memory and executed by the processing system 1110. The device applications may also include a device manager, such as any form of a control application, software application, signal processing and control module, code that is native to a particular device, a hardware abstraction layer for a particular device, and so on. In this example, the device applications also include a user authentication application 1116 that implements aspects of multi-factor authentication via network-connected devices, such as when the example device 1102 is implemented as any of the mesh network devices, computing devices, and/or cloud-based services described herein.

The device 1102 also includes an audio and/or video system 1118 that generates audio data for an audio device 1120 and/or generates display data for a display device 1122. The audio device and/or the display device include any devices that process, display, and/or otherwise render audio, video, display, and/or image data, such as the image content of a digital photo. In implementations, the audio device and/or the display device are integrated components of the example device 1102. Alternatively, the audio device and/or the display device are external, peripheral components to the example device. In implementations, at least part of the techniques described for multi-factor authentication via network-connected devices may be implemented in a distributed system, such as over a “cloud” 1124 in a platform 1126. The cloud 1124 includes and/or is representative of the platform 1126 for services 1128 and/or resources 1130.

The platform 1126 abstracts underlying functionality of hardware, such as server devices (e.g., included in the services 1128) and/or software resources (e.g., included as the resources 1130), and connects the example device 1102 with other devices, servers, etc. The resources 1130 may also include applications, such as the user authentication system 514, and/or data that can be utilized while computer processing is executed on servers that are remote from the example device 1102. Additionally, the services 1128 and/or the resources 1130 may facilitate subscriber network services, such as over the Internet, a cellular network, or Wi-Fi network. The platform 1126 may also serve to abstract and scale resources to service a demand for the resources 1130 that are implemented via the platform, such as in an interconnected device environment with functionality distributed throughout the system 1100. For example, the functionality may be implemented in part at the example device 1102 as well as via the platform 1126 that abstracts the functionality of the cloud 1124.

Although aspects of multi-factor authentication via network-connected devices have been described in language specific to features and/or methods, the subject of the appended claims is not necessarily limited to the specific features or methods described. Rather, the specific features and methods are disclosed as example implementations of code generation of target-specific data models, and other equivalent features and methods are intended to be within the scope of the appended claims. Further, various different implementations are described, and it is to be appreciated that each described implementation can be implemented independently or in connection with one or more other described implementations.

1. A system for generating a behavioral authentication factor, the system comprising:
a service configured to:
receive indications of user activity from multiple network-connected devices that are monitored by the service;
compose a training dataset from the received indications; and
generate the behavioral authentication factor by training a model using the training dataset.

2. The system of claim 1, wherein the received indications include sensor readings, control commands, user interactions, or any combination thereof from the network-connected devices.

3. The system of claim 2, wherein the received indications include user location information.

4. The system of claim 1, wherein the training dataset includes structure resource data or external resource data.

5. The system of claim 4, wherein the structure resource data includes aggregations of traits of the network-connected devices in a structure that are useful in providing services, information related to users and user accounts that are associated with various services provided in relation to the structure, and a home graph that describes connections and relationships between the network-connected devices, elements of the structure, and users.

6. The system of claim 4, wherein the external resource data includes data from partner cloud services, calendaring services, email services, news services, weather services, or location-based services for mobile devices.

7. The system of claim 1, further comprising a user authentication service configured to determine an authentication confidence level using the generated behavioral authentication factor.

8. A method for authenticating a user identity based on a behavioral authentication factor, the method comprising:
receiving, at a service, indications of user activity from multiple network-connected devices that are monitored by the service;
detecting a pattern of activities in the received indications of user activity;
comparing the pattern of activities to the behavioral authentication factor;
determining a confidence level that the pattern of activities corresponds to the behavioral authentication factor; and
authenticating the identity of the user if the determined confidence level exceeds a threshold value for authentication of the identity of the user.

9. The method of claim 8, wherein the determining the confidence level includes determining the confidence level that the pattern of activities matches the behavioral authentication factor.

10. The method of claim 8, wherein the behavioral authentication factor is a model of user behavior, and wherein the model of user behavior is generated by training a machine learning algorithm with user activities received from the network-connected devices and monitored by the service.

11. The method of claim 10, wherein the network-connected devices include a security sensor, a camera, a thermostat, a motion sensor, a light switch, a user device, a smart speaker, or any combination thereof.

12. The method of claim 8, wherein when the detected pattern of activities does not match a learned pattern of behaviors a notification is sent to the user.

13. The method of claim 12, wherein the notification is sent to the user device by the service.

14. The method of claim 8, wherein the received indications of user activity include location information for the user.

15. A system to authenticate a user identity based on a user's passive or active interactions with network-connected devices, the system comprising:
a user authentication service configured to:
receive an indication of a user identity;
determine a device, of the network-connected devices associated with the user identity, for a user interaction;
request the user interaction via the device;
monitor the device to receive an indication of the user interaction with the device; and
based on the received indication of the user interaction, authenticate the identity of the user.

16. The system of claim 15, wherein to determine the device, the user authentication service is configured to determine a predetermined network-connected device, and the predetermined network-connected device is known to the authentication service and to the user.

17. The system of claim 16, wherein the network-connected devices are disposed about a structure, and wherein the authentication indicates the user is authorized to access to the structure.

18. The system of claim 15, wherein to determine the device for the user interaction, the user authentication service is configured to select the device from the network-connected devices that are associated with the user identity, and wherein the indication of the user interaction includes an identification of the determined device.

19. The system of claim 15, wherein the network-connected devices include a motion sensor, a security sensor, a thermostat, a camera, a smart speaker, or a light switch.

20. The system of claim 15, wherein the requested user interaction is facial recognition and the device is a camera, or wherein the requested user interaction is voice recognition and the device is a smart speaker.
